(19) United States
(12) Patent Application Publication
(10) Pub. No.: US 2004/0102344 A1
(43) Pub. Date: May 27, 2004

(54) Compostion for rust removal and method of removing rust with the same

(76) Inventors: Shozo Nakayama, Kawanishi-shi Hyogo (JP); Shigeru Ura, Kitakatsuragi-gun (JP)

Correspondence Address: BIRCH STEWART KOLASCH & BIRCH, PO BOX 747, FALLS CHURCH, VA, 22040-0747, US

(21) Appl. No.: 10/474,254

(22) PCT Filed: Apr. 25, 2002
(86) PCT No.: PCT/JP02/04184

(30) Foreign Application Priority Data
Apr. 25, 2001 (JP) 2001-127889

(51) Int. Cl. C11D 1/00

(52) U.S. Cl. 510/202

(57) ABSTRACT

A composition for rust removal which is highly effective in removing rust. The composition is a water-soluble composition which comprises a basic compound, a water-soluble metal chelating agent, and thiourea dioxide and which, when dissolved in an aqueous medium, gives an alkaline solution.

### TECHNICAL FIELD

The present invention relates to a composition for rust removal and a method of removing rust with the same. In particular, the present invention relates to the composition for rust removal useful for preventing deterioration in performance caused by adhesion of rust to machines and instruments for medical use, such as a dialyzer, machines and instruments for water treatment equipped with a separating membrane for water treatment, water pipes, and facilities for hot springs, facilities for house and surroundings, such as mortar, building stone etc., or for overcoming inconvenience in hygiene or outward appearances and to a method of removing rust with the same.

### BACKGROUND ART

Rust (particularly iron rust) occurs in various environments of machines, facilities etc. in contact with water, to deteriorate the performance of the machines and facilities, and thus there is a need for removal of the rust. Accordingly, various methods of removing rust have been proposed. For example, an acid cleaning method, an alkali cleaning method (chelate cleaning method), an electrolytic cleaning method etc. are known as conventional methods of removing rust.

Specifically, there is a chelate cleaning method utilizing the chelating force of sodium gluconate exerted on iron under alkaline conditions, a chelate cleaning method utilizing a chelating force possessed by ammonium thioglycolate exerted on heavy metal as shown in Japanese Unexamined Patent Publication No. SHO 60(1985)-218488, a method which can also be called a reduction chelate cleaning method (this name is attributable to use of a reducing agent and a chelating agent) by using an alkaline preparation to which hydrazine, ammonium sulfide, hydrosulfite and ethylenediaminetetraacetic acid were added as shown in Japanese Unexamined Patent Publication No. HEI 10(1998)-251694, or an electrolytic method using an reducing agent wherein sulfoxylic acid, dithionous acid, sulfurous acid, pyrosulfurous acid, pyrosulfuric acid, thiosulfuric acid, peroxomonosulfuric acid, peroxodisulfuric acid, polythionic acid or hydrosulfurous acid, or a salt thereof, is used as the reducing agent in a neutral salt electrolyte for the purpose of removing mil scale of stainless steel as shown in Japanese Unexamined Patent Publication No. HEI 8(1996) -92800.

Among these conventional methods of removing rust, the electrolytic cleaning method requires large-scale treatment facilities and thus has a problem of higher costs in rust removal. On the other hand, the chelate cleaning method or reduction chelate cleaning method as an easy rust-removing method which unlike the electrolytic cleaning method, does not require such large-scale treatment facilities has the following problems to be solved:

(1) The treatment at low temperatures is poor in the effect.

(2) The rust-removing speed is low (long treatment is necessary for exhibiting the effect).

(3) The treatment solution in a low concentration is poor in the effect (diluted treatment solution cannot be used).

(4) A treatment solution containing ammonium thioglycolate, ammonium sulfide, hydrosulfite etc. generates an offensive smell.

(5) The time in which the treatment solution is usable is short (hydrosulfite type).

(6) The balance between the total treatment cost and the treatment effect is insufficient.

### DISCLOSURE OF INVENTION

The present inventors made extensive study for solving these problems, and as a result, they found that a rusted surface of a material to be treated is treated by contacting with an alkaline solution prepared by dissolving thiourea dioxide in the coexistence of a basic compound and a water-soluble metal chelating agent, whereby the problems can be solved.

Accordingly, the present invention provides a composition for rust removal which is a water soluble composition comprising a basic compound, a water-soluble metal chelating agent and thiourea dioxide, said composition showing alkalinity upon dissolution in an aqueous medium.

Further, the present invention provides a method of removing rust comprising the step of bringing an alkaline solution of the composition for rust removal in an aqueous medium into contact for a predetermined time with a rusted surface of a material to be treated.

### EMBODIMENTS OF THE INVENTION

The present invention falls, in respect of use of a reducing agent, under the scope of a reduction chelate method, but it has been confirmed through experiments that a composition for rust removal containing thiourea dioxide as the reducing agent is significantly superior in the level of effect to a composition for rust removal containing hydrosulfite used usually in the art.

It has also been confirmed through experiments that such excellent effect of the present invention is attributable to the synergistic effect of a combination of a basic compound, a water-soluble metal chelating agent and thiourea dioxide as the constitution of the composition for rust removal used, and a combination of only two of the components cannot achieve the object.

Hereinafter, the method of the present invention is described in detail.

Thiourea dioxide used in the present invention is also called aminoiminomethanemethanesulfinic acid or formamidinesulfinic acid. Usually, thiourea dioxide is marketed in a powdery form, and a commercial product, for example a product commercially available under the trade name “TEC LIGHT” from Asahi Denka Kogyo K. K. can be used. Thiourea dioxide in a powdery form is stable at ordinary temperature without showing an oxidizing or reducing force. However, thiourea dioxide has such a property that it is gradually decomposed with water or a basic compound or by heating, to generate sulfinic acid having a strong reducing force. The mechanism (reaction) for generating sulfinic acid can be exemplified in the following chemical scheme:

NH₂C(═SO₂)NH₂→NH═C(SO₂H)NH₂→NH₂CONH₂+H₂SO₂ (thiourea dioxide→formamidinesulfinic acid→urea+sulfinic acid) (1)

NH═C(SO₂H)NH₂+2NaOH→NH₂CONH₂+H₂SO₂+H₂O (formamidinesulfinic acid+caustic soda→urea+sulfinic acid+water) (2)

The basic compound used in the present invention includes caustic alkalis represented by sodium hydroxide and potassium hydroxide; ammonium hydroxide (ammonia water) and various amines. Further, salts of the above basic compound with weak acids, for example alkali metal salts of tripolyphosphoric acid, hexametaphosphoric acid, pyrophosphoric acid, carbonic acid, bicarbonic acid, orthosilicic acid, metasilicic acid, and various carboxylic acids can also be used insofar as they are water-soluble and show alkalinity. These basic compounds can be used alone or as a mixture of two or more thereof.

Among these basic compounds, caustic alkalis or salts of weak acids with caustic alkalis can be used particularly preferably because these alkalis or salts have excellent characteristics in usability such as less evaporation and strong alkalinity permitting use in a lower amount of the salt used.

As the metal chelating agent used in the present invention, any compounds can be used insofar as they have water solubility. The metal chelating agent is preferably the one having water solubility to permit the composition for rust removal to be maintained in a uniformly dissolved state in an aqueous medium at the time of rust removal. Specifically, the metal chelating agent has preferably a water solubility of 1 g or more, more preferably a water solubility of 10 g or more, per 100 g water, depending on the type of the chelating agent.

Examples of the water-soluble metal chelating agent used in the present invention include aminocarboxylic acid-based compounds such as ethylenediaminetetraacetate (EDTA), diethylenetriaminepentaacetate (DTPA), triethylenetetraminehexaacetate (TTHA), glutamic diacetate (GLDA), hydroxyethylethylenediaminetriacetate (HEDTA), dihydroxyethylethylenediaminediacetate (DHEDDA), 1,3-propanediaminetetraacetate (1,3-PDTA), 1,3-diamino-2-hydroxypropanetetraacetate (DPTA-OH), nitrilotriacetate (NTA), hydroxyethyliminodiacetate (HIDA), dihydroxyethyl glycine (DHEG) etc.; phosphonic acid-based compounds such as phosphonobutane tricarboxylate (PBTC), nitrilotris(methylenephosphonate) (NTMP), hydroxy ethylidene diphosphonate (HEDP) etc.; and hydroxycarboxylic acid-based compounds such as citrate, malate, glycolate, lactate, gluconate etc. These salts include alkali metal salts, ammonium salts etc.

These compounds in the composition for rust removal in the form of an aqueous solution or in the solution for removing rust occur in a substantially salt form depending on the basic compound in the composition for rust removal. The salt form is advantageous in increasing solubility in water and in preparing a concentrated aqueous solution. Some of the basic compounds described above, such as tripolyphosphate, have a metal chelating action, and by incorporation thereof into the composition for rust removal, the action thereof can also be utilized.

The metal chelating agents can be used alone or as a mixture of two or more thereof. Among these compounds, aminocarboxylic acid-based compounds particularly have a high chelating ability, and are thus excellent in the use effect and particularly preferable.

In the composition for rust removal, the water-soluble metal chelating agent is preferably 0.01 to 10 parts by weight, more preferably 0.1 to 5 parts by weight, relative to 1 part by weight of thiourea dioxide. Given the metal chelating agent within the range described above, the rust-removing effect can further be improved. The amount of the basic compound used is not particularly limited insofar as the pH of the solution containing the composition for rust removal at the time of rust-removing treatment is in the alkaline range (pH 7 or more, preferably 8 or more, more preferably 9.5 or more). However, when the amount of the basic compound used is too high, disposal of waste liquor after the rust-removing treatment is difficult, and thus the amount of the basic compound used, though being varied depending on the type of the compound, is preferably reduced in the maximum degree within such a range as to achieve the desired rust-removing effect.

Besides the three components described above, other components contained usually in the composition for rust removal may also be contained in the composition for rust removal of the present invention in such a range that the effect of the present invention is not deteriorated. Such other components include a surfactant for the purpose of improving the efficiency of treatment by promoting permeation into a treatment layer of a material to be treated, as well as a reducing agent other than thiourea dioxide, for example hydrosulfite, sodium sulfite, sodium thiosulfate etc.

The composition for rust removal of the present invention can be in a solid form or a solution form dissolved in an aqueous medium, or in a combination of the two forms.

First, the composition for rust removal in a solid form is advantageous in easy handling and excellent shelf stability. In this case, the composition for rust removal is dissolved in an aqueous medium just before rust-removing treatment, to prepare a rust-removing treatment solution. The preparation form is specifically in the form of a single preparation having the three components mixed therein, two preparations wherein one preparation contains two components and the other preparation contains one component, or three preparations containing the three components respectively. The basic compound poor in moisture absorption, such as sodium carbonate, is preferably used for improving shelf stability. The composition for rust removal in a solid form includes the one in a bulky form such as powder and pellet forms. In these forms, the composition in a powder form is preferably used because of higher solubility.

Then, the composition for rust removal in a solution form dissolved in an aqueous medium is advantageous in that a procedure of dissolving the respective components at the time of rust removal can be omitted. The aqueous medium refers to water or a mixture of water and a water-soluble organic solvent. The water-soluble organic solvent is not particularly limited, and includes solvents usually used in the art. Examples thereof include alcohols such as methanol, ethanol, isopropyl alcohol etc., ethylene glycol, propylene glycol, acetone, etc. The amount of the water-soluble organic solvent used can be determined suitably in such a range as not to influence the solubility of the three components. Further, the concentration of the three components is not particularly limited insofar as at least the rust-removing effect occurs at that concentration.

The three components may be dissolved in one aqueous medium, or two components and one component may be dissolved respectively in aqueous mediums followed by mixing the resulting solutions of the components at the time of rust removal. The order of adding the respective components for preparing the composition for rust removal is not particularly limited. In the three components, thiourea dioxide is decomposed in the presence of the basic compound, and thus the latter method is useful.

The combination of the solid and solution forms is a combination of a solution of one or two components in the three components and a solid of the remainder component. In the three components, thiourea dioxide is decomposed gradually in the presence of water, and thus this combined form is useful. That is, a compounded solution storable (stable) for a long time to which thiourea dioxide is not added is first prepared, and thiourea dioxide is then dissolved in the compounded solution just before rust removal, whereby a treatment solution can be prepared. This method is advantageous in that the operation of preparing the treatment solution just before rust removal can be simplified.

In the above composition for rust removal, the composition in a solution form is described in more detail.

In the case of the composition in a solution form, the water-soluble metal chelating agent is contained as an active ingredient in an amount of preferably 0.01% by weight or more, more preferably 0.02% by weight or more. Thiourea dioxide is contained in an amount of preferably 0.01% by weight or more, more preferably 0.02% by weight or more. The amount of the basic compound added, though being varied depending on the type, is an amount necessary for regulating the pH of the treatment solution at least in the alkaline range. Preferably, the amount of the basic compound added is for example 0.001% by weight or more.

The upper limit of the respective components can theoretically be an amount to secure the water solubility of the components. Generally, the upper limit of the components in the preparing step is about 30% by weight.

To exhibit an effective rust-removing effect, the pH of the solution just after preparation should be at least alkaline. This regulation of the pH of the solution in the alkaline range is a requirement not only for increasing the water-solubility and dissolution velocity of thiourea dioxide in an aqueous treatment solution to enable preparation of a rust-removing solution containing a higher amount of thiourea dioxide but also for permitting thiourea dioxide to exhibit a stronger reducing force.

That is, thiourea dioxide is characterized in that the amount thereof dissolved in water is increased in the presence of the basic compound. When the amount of the basic compound is small, there arises a problem that a part of thiourea dioxide is not dissolved thus remaining in the solution, the dissolution velocity is significantly lowered, generation of ammonia accompanying decomposition of a part of the components is increased, and a reduced component generated by dissolution (reaction) of thiourea dioxide cannot be effectively utilized.

Specifically, the pH just after preparation is preferably 8 or more, more preferably 9.5 or more. The amount of thiourea dioxide that can be dissolved at ordinary temperature (25° C.) in the presence of sodium hydroxide (NaOH) generally called caustic alkali can be exemplified as follows. An amount of about 7 weight-% thiourea dioxide dissolved can be secured in 3 weight-% NaOH solution, an amount of about 15 weight-% thiourea dioxide in 6 weight-% NaOH solution, and an amount of about 25 weight-% thiourea dioxide in 9 weight-% NaOH solution. When potassium hydroxide is used, there is almost the same tendency. To obtain the composition for rust removal in a solution form predetermined to contain thiourea dioxide in a higher concentration, it is necessary to consider that the basic compound added is also increased.

There is also the case where some water-soluble metal chelating agents such as aminocarboxylic acid compounds hardly secure sufficient water-solubility unless they are converted into alkali salts. When such metal chelating agents are used, those previously converted into alkali salts are used, or an additional basic compound in such an amount to be able to convert the chelating agents into alkali salts is added in the compounding step. Thus, the basic compound is determined preferably in consideration of the amount for dissolving thiourea dioxide, the amount of the basic compound consumed by the metal chelating agent, the alkalinity of the basic compound, etc.

The basic compound may necessarily not be added in large excess, and may be added in such a range that the pH of the treatment solution just preparation is 13 or less, generally 12.5 or less. Addition of the basic compound in excess is not preferable because a rusted material treated with such a treatment solution may be corroded, or special treatment of waste liquor may be necessary.

After the treatment solution is prepared, the pH of the composition for rust removal in a solution form is lowered with time toward the neutral side, during which the pH is preferably in the alkaline side. For example, the pH of the treatment solution after several hours is preferably in the range of about 7 to 9.

Hereinafter, the method of removing rust according to the present invention is described.

First, the method of removing rust according to the present invention can be useful for removing rust occurring on machines and instruments for medical use, such as a dialyzer, machines and instruments for water treatment equipped with a separating membrane for water treatment, water pipes, and facilities for hot springs, facilities for house and surroundings, such as mortar, building stone etc.

The rust intended herein is the one adhering to a material to be treated, and the rust may be rust occurring on the material to be treated or rust transferred from another place to the material to be treated. The rust is mainly iron rust based on iron hydroxide, oxide and sulfide, and the method of the invention exhibits a significantly excellent effect on removal of iron rust particularly red rust regarded as being based on iron oxide hydroxide (FeO(OH)). Further, the adhering rust may be composite rust containing inorganic materials such as other metallic compounds etc., proteins, fats, hydrocarbons, and organic materials such as those derived from microorganisms.

The composition for rust removal in a solid form is dissolved to a predetermined concentration in an aqueous medium to prepare the rust-removing treatment solution; the composition for rust removal in a solution form is used as such or diluted to a predetermined concentration with an aqueous medium; and the composition for rust removal in a combined form of solid and solution forms can be converted into the rust-removing treatment solution by dissolving component(s) in a solid form in other component(s) in a solution form before or after being diluted to a predetermined concentration with an aqueous medium.

The total content of the three components in the rust-removing treatment solution is regulated such that in the step of rust removal, efficient treatment is feasible depending on the amount and state of rust adhering to a material to be treated. Generally, the total content of the components is preferably 0.05 to 2% by weight. Rust can be removed by the solution at a concentration of 2% by weight or more, but the efficiency of rust removal is not changed at a lower concentration, and thus the effect and efficiency of the treatment are not so improved in many cases even if a high conc. solution is used.

The treatment solution (final treatment solution) used in the step of rust removal can also be prepared by preparing a high conc. treatment solution and then diluting it suitably to give a treatment solution containing the components in predetermined amounts (stock solution dilution system), and this system is useful as a method of obtaining a large amount of the treatment solution by successively diluting the high conc. solution as the stock solution or as a system capable of reducing a space for storing the treatment solution. Preparation of the treatment solution in this stock solution dilution system can be applied in the range of 1- to 500-fold dilution depending on the concentrations of the components in the stock solution prepared, and the rust-removing method which can use a high degree of dilution to exhibit a satisfactory rust-removing effect was accomplished for the first time in the present invention.

The treatment solution thus compounded and prepared is subjected to treatment of a material to be treated for achieving the desired rust-removing effect.

The method of rust removal is achieved basically by contacting the aqueous treatment solution of the present invention for a predetermined time with a rusted surface of a material to be treated. Rust removal can be carried out specifically by a method wherein a material to be treated is dipped in the treatment solution, a method wherein the treatment solution is passed through a device having a treated surface capable of contacting with the solution, a method wherein a surface to be treated is coated with the treatment solution, a method wherein a surface to be treated is sprayed with the treatment solution, etc.

The time in which the surface to be treated is contacted with the treatment solution is varied depending on conditions such the state of rust adhering to a material to be treated, the temperature of the solution at the time of treatment, etc., but is usually preferably about 5 minutes to about 1 hour. As the temperature of the treatment solution is increased, the effect of the treatment appears more rapidly and the time necessary for the treatment can be reduced, but usually the treatment with the solution at ordinary temperatures can achieve the desired effect in many cases.

After treatment by contacting with the solution for a predetermined time, the adhering treatment solution is preferably washed away with water, if necessary followed by subjecting the treated material to post-treatment such as drying.

### EXAMPLES

Hereinafter, the present invention is described in more detail by reference to the Examples and Comparative Examples, but the present invention is not limited thereto.

One feature of the composition for rust removal of the present invention lies in selection of the reducing agent excellent in strong reducing force and durability thereof, and in that the composition for rust removal is used under such alkaline conditions that the metal chelating agent facilitating dissolution and removal of rust can efficiently function. The reducing force of the composition for rust removal and the durability of the reducing force can be roughly grasped by measuring the oxidation-reduction potential (ORP) of the treatment solution, and have been confirmed in the following examples.

In the Examples and Comparative Examples below, “%” refers to % by weight unless otherwise noted.

### Examples 1 to 4 and Comparative Examples 1 to 3

### Experiment 1: Examination of the Influence of the Compounding Ratio of the Components on Effect and Characteristics

### 1) Experimental Conditions

### \mathring{1} Materials Used

Reducing agent: thiourea dioxide (powder of 99% or more purity) . . .

TEC LIGHT manufactured by Asahi Denka Kogyo K. K. (Japan)

Basic compound: sodium hydroxide (25% aqueous solution)

potassium hydroxide (25% aqueous solution)

Metal chelating agent: EDTA·4H (powder of 99% or more purity)

CHELEST 2A manufactured by Chelest Co (Japan).

### \mathring{2} Preparation of the Treatment Solution

Preparation of EDTA·3K salt solution: 1 mole (292 g) of EDTA·4H and 53.5 g water (RO water) filtered with a reverse osmosis filter were added to 3 moles of KOH (168 g=672 g of 25% aqueous solution), to prepare an aqueous solution containing 40% EDTA·3K salt. The pH of this aqueous solution was 7.6.

Preparation of EDTA·2K salt solution: 1 mole (292 g) of EDTA·4H and 100 g water (RO water) filtered with a reverse osmosis filter were added to 2 moles of KOH (112 g=448 g of 25% aqueous solution), to prepare an aqueous solution containing 40% EDTA·2K salt. The pH of this aqueous solution was 4.3.

The aqueous solutions of EDTA·3K and EDTA·2K and other starting materials used were dissolved in RO water in a combination and amounts shown in Table 1, to give compositions for rust removal. The resulting compositions for rust removal were subjected to the following evaluation of characteristics such as rust-removing effect etc.

### \mathring{3} Evaluation of the Rust-Removing Effect

### Material to be Treated

a) Rusted silicon tube #G . . . A tube was fit in a dialyzer and used for 1 year or more, during which a solution and water were passed therethrough, whereby brown rust adhered to the inside of the tube (internal diameter=9 mm), and this tube was cut into a piece of 1.5 cm in length and used. The adhering rust is based on iron rust estimated to be FeO(OH) containing a small amount of proteins (the presence of iron was confirmed by EPMA analysis).

b) Cloth polluted with FeO(OH) . . . α-FeO(OH) (iron oxide hydroxide) was adsorbed uniformly in an amount of about 2 g/m² as a substitute for rust into 200 g/m² Tetron Tropical (woven cloth) manufactured by Teijin Ltd., and the resulting dark yellow cloth was cut into a 3×3 cm² piece and used.

Method of removing rust: The material to be treated was treated by dipping in the treatment solution at 25° C. for a predetermined time in a treatment bath ratio of 1:200 by weight (sample weight:treatment solution), and after the treatment, the treated material was removed, washed with RO water, air-dried and subjected to evaluation of the state of rust removal.

### Method of Evaluation of Characteristics

i) Evaluation of the state of rust removal: The state of adhering rust on the treated material was evaluated with the naked eye in a numerical value of 1 to 5[1=state of much adhesion→5=no adhesion of rust, i.e. complete removal].

ii) Measurement of treatment solution pH: A pH meter with glass electrodes was used.

### 2) Results: Shown in Table 1

TABLE 1

| | | | | Formulation No. | | | | | | | |
|---|---|---|---|---|---|---|---|---|---|---|---|
| | | | | | | | | | | | Control |
| Items for evalution | | | | Com. | | | | | Com. | Com. | RO |
| of characteristics | | | | Ex. 1 | Ex. 1 | Ex. 2 | Ex. 3 | Ex. 4 | Ex. 2 | Ex. 3 | water |
| Composition | | Amount of | EDTA.2K | | | | | | 0.075 | | |
| | | active | EDTA.3K | | 0.036 | 0.090 | 0.144 | 0.180 | | 0.090 | |
| | | ingredient/ | NaOH | 0.09 | 0.08 | 0.045 | 0.018 | 0 | | 0.045 | |
| | | 100 g | thiourea | 0.2 | 0.2 | 0.2 | 0.2 | 0.2 | 0.2 | | |
| | | | dioxide | | | | | | | | |
| | | | RO water | 99.71 | 99.68 | 99.67 | 99.63 | 99.62 | 99.73 | 99.87 | 100 |
| | | | total | 100 | 100 | 100 | 100 | 100 | 100 | 100 | 100 |
| | | Content of | EDTA.4H | | 0.026 | 0.065 | 0.103 | 0.129 | 0.065 | | |
| | | each ingredient | (KOH) | | 0.015 | 0.037 | 0.059 | 0.074 | 0.025 | 0.037 | |
| | | in the treatment | NaOH + KOH | 0.09 | 0.095 | 0.082 | 0.077 | 0.074 | 0.025 | 0.037 | |
| | | solution (%) | thiourea | 0.2 | 0.2 | 0.2 | 0.2 | 0.2 | 0.2 | | |
| | | | dioxide | | | | | | | | |
| Results of | Treatment | | elapsed time | pH measurement results | | | | | | | |
| evaluation | solution pH | | just after | 11.0 | 10.35 | 9.53 | 8.23 | 7.20 | 4.60 | 12.3 | 6.00 |
| characteristics | | | preparation | | | | | | | | |
| | | | after 60 | 9.30 | 8.79 | 8.10 | 7.52 | 6.40 | 4.45 | 12.2 | 6.04 |
| | | | minutes | | | | | | | | |
| | Degree of | material | treatment | Evaluation results of degree of rust removal | | | | | | | |
| | rust | treated | time | | | | | | | | |
| | removal | silicon | 40 minutes | 1.2 | 2.5 | 4.0 | 3.5 | 2.4 | 1.1 | 1.0 | 1.0 |
| | | tube #G | 90 minutes | 1.5 | 3.8 | 5.0 | 4.0 | 3.5 | 1.2 | 1.0 | 1.0 |
| | | cloth polluted | 40 minutes | 1.3 | 3.0 | 4.3 | 4.0 | 2.6 | 1.1 | 1.0 | 1.0 |
| | | with FeO(OH) | 90 minutes | 1.5 | 4.0 | 5.0 | 4.8 | 3.8 | 1.2 | 1.0 | 1.0 |

<Point of the results> The treatment solutions in Examples 1 to 4 showed a rust-removing effect superior to that of Comparative Examples 1 to 3. As is evident from comparison with the Comparative Examples, the effect is demonstrated synergistically when the components in the present invention, that is, thiourea dioxide, the basic compound (NaOH+KOH) and the metal chelating agent (EDTA) are contained, and the treatment solution is alkaline.

### Examples 5 to 10 and Comparative Examples 4 to 8

### Experiment 2: Examination of the Influence of the Type of Ingredient on Effect and Characteristics, and Comparison of Characteristics with a Conventional Product

### 1) Experimental Conditions

### \mathring{1} Materials Used

Reducing agent: the same thiourea dioxide as in Experiment 1; hydrosulfite (powder of 85% or more purity), that is, hydrosulfite conc. manufactured by Koei Kagaku Co., Ltd (Japan).

Basic compound: sodium hydroxide (25% aqueous solution)

sodium tripolyphosphate (anhydrous powder)

Metal chelating agent: EDTA·4Na.4H₂O (powder of 84% or more purity), i.e. CHELEST 400 manufactured by Chelest Co.

DTPA·5Na (aqueous solution of 40% or more purity), i.e. CHELEST P manufactured by Chelest Co.

GLDA·4Na (aqueous solution of 40% or more purity), i.e. CHELEST CMG-40 manufactured by Chelest Co.

sodium citrate (2Na.2H₂O powder of 88% or more purity) manufactured by Fuso Kagaku Co., Ltd (Japan).

Comparative rust-removing agent: rust-removing agent based on ammonium thioglycolate (abbreviated into TGA)

A solution (stock solution) of the comparative rust-removing agent having the following composition was prepared according to Example 5 in Japanese Unexamined Patent Publication No. SHO 60(1985)-218488 was prepared and used.

### Composition of the Ammonium Thioglycolate-Based Rust Removing Agent (TGA-1)

| | | |
|---|---|---|
| thioglycolic acid | 37 | g |
| 28% ammonia water | 50.5 | g |
| ethyl cellosolve | 12 | g |
| sodium dodecylbenzenesulfonate | 0.5 | g |
| total | 100.0 | g |

\mathring{2} Preparation of the treatment solution: The above starting materials used were dissolved in RO water in a combinations and amounts shown in Table 2, to give compositions for rust removal. The resulting compositions for rust removal were subjected to the following evaluation of characteristics such as rust-removing effect etc. With respect to TGA-1, its stock solution and 10-fold aqueous dilution were examined.

\mathring{3} Evaluation of the rust-removing effect

| | |
|---|---|
| Material to be treated: | Rusted silicon tube #G (the same |
| | as in Experiment 1) |
| | Cloth polluted with FeO(OH) (the |
| | same as in Experiment 1) |
| Method of removing rust, method of | The same as in Experiment 1 |
| evaluating characteristics: | |

### 2) Experimental Results: Shown in Table 2

TABLE 2

| | | Formulation No. | | | | | | | | | | | |
|---|---|---|---|---|---|---|---|---|---|---|---|---|---|
| | | | | | | | | | | | | | Control |
| Items for evaluation | | | | | | | Ex. | Com. | Com. | Com. | | | RO |
| of characteristics | | Ex. 5 | Ex. 6 | Ex. 7 | Ex. 8 | Ex. 9 | 10 | Ex. 4 | Ex. 5 | Ex. 6 | Ex. 7 | Ex. 8 | water |
| Composition | EDTA.4Na | 0.22 | 0.11 | | | | | 0.22 | | | | | |
| and active | DTPA.5NA | | | 0.22 | | | | | | | | | |
| ingredient % | GLDA.4Na | | | | 0.22 | | | | | | | | |
| in treatment | sodium citrate | | | | | 0.22 | | | 0.22 | 0.44 | | | |
| solution | sodium | | | | | | 0.22 | | | | | | |
| | tripolyphosphate | | | | | | | | | | | | |
| | NaOH | 0.040 | 0.020 | 0.040 | 0.040 | 0.040 | 0.040 | | | | | | |
| | KOH | 0.033 | 0.016 | 0.033 | 0.033 | 0.033 | 0.033 | | | | | | |
| | thiourea dioxide | 0.19 | 0.095 | 0.19 | 0.19 | 0.19 | 0.19 | | | | | | |
| | hydrosulfite | | | | | | | 0.19 | 0.19 | 0.38 | | | |
| | TGA-1 (TGA %) | | | | | | | | | | Stock | 10-fold | |
| | | | | | | | | | | | | solution | aqueous |
| | | | | | | | | | | | | (44.0) | dilution |
| | | | | | | | | | | | | | (4.4) |
| Evaluation | | | | | | | | | | | | | |
| results of | | | | | | | | | | | | | |
| characteristics | | | | | | | | | | | | | |
| Treatment | just after | 10.88 | 10.46 | 10.92 | 10.66 | 10.19 | 10.39 | 8.33 | 6.39 | 6.37 | 6.81 | 6.67 | 6.01 |
| solution | preparation | | | | | | | | | | | | |
| pH | after 1.0 hour | 10.19 | 9.83 | 10.31 | 10.04 | 9.55 | 9.72 | 7.80 | 6.33 | 6.33 | 6.83 | 6.69 | 6.04 |
| | after 2 hours | 9.81 | 9.16 | 9.93 | 9.76 | 9.27 | 9.40 | 7.27 | 6.29 | 6.30 | 6.85 | 6.74 | 6.05 |
| Degree of | | | | | | | | | | | | | |
| rust removal | | | | | | | | | | | | | |
| silicon | treatment for | 4.0 | 3.3 | 3.9 | 4.0 | 3.0 | 3.2 | 1.5 | 1.8 | 2.0 | 1.3 | 1.0 | 1.0 |
| tube #G | 0.5 hour | | | | | | | | | | | | |
| | treatment for | 5.0 | 4.7 | 5.0 | 5.0 | 4.2 | 4.4 | 2.0 | 2.3 | 3.0 | 1.8 | 1.2 | 1.0 |
| | 1.0 hour | | | | | | | | | | | | |
| | treatment for | 5.0 | 5.0 | 5.0 | 5.0 | 4.6 | 4.7 | 2.5 | 2.8 | 3.6 | 2.3 | 1.4 | 1.0 |
| | 1.5 hours | | | | | | | | | | | | |
| cloth | treatment for | 3.8 | 3.0 | 3.8 | 3.7 | 2.8 | 3.1 | 1.0 | 1.1 | 1.5 | 1.2 | 1.1 | 1.0 |
| polluted | 0.5 hour | | | | | | | | | | | | |
| with | treatment for | 4.9 | 4.2 | 4.9 | 4.8 | 3.6 | 4.0 | 1.2 | 1.3 | 1.9 | 1.4 | 1.2 | 1.0 |
| FeO(OH) | 1.0 hour | | | | | | | | | | | | |
| | treatment for | 5.0 | 4.8 | 5.0 | 5.0 | 4.4 | 4.6 | 1.6 | 1.6 | 2.6 | 1.6 | 1.4 | 1.0 |
| | 1.5 hours | | | | | | | | | | | | |

Note)
Generation of a stimulative smell regarded as sulfite gas from the treatment solutions in Comparative Examples 2 to 4 was recognized, but generation of such smell was not recognized in the treatment solutions in Examples 5 to 10.

<Point of the results> The treatment solutions in Examples 5 to 10 exhibited an evidently superior rust-removing effect to that of the treatment solutions in Comparative Examples 4 to 6 using hydrosulfite. Further, the treatment solutions in Examples 5 to 10 exhibited an evidently superior rust-removing effect although the concentration of the active ingredients therein was very lower than the concentration of the active ingredient in the ammonium thioglycolate-based rust-removing agent (TGA-1) solutions (Comparative Examples 7 to 8). Further, the smell from the treatment solutions in Examples 5 to 10 was evidently lower from that of the treatment solutions in Comparative Examples 4 to 8.

### Example 11 and Comparative Example 9

### Example 3

### Examination of Durability of the Effect of the Prepared Treatment Solution

1 Experimental conditions

\mathring{2} Starting materials used: the same as in Experiment 2.

\mathring{2} Preparation of the treatment solution: The starting materials used were dissolved in RO water in combinations and amounts shown in Table 3, to give compositions for rust removal. The resulting compositions for rust removal were subjected to the following evaluation of characteristics such as rust-removing effect etc. The prepared treatment solutions were stored at 25° C. for a predetermined time.

\mathring{3} Evaluation of the rust-removing effect:

Material to be treated: Rusted silicon tube #H obtained under the same environment as that of the tube (#G) in Experiment 1, and the composition of its adhering rust is similar to that of the rust on #G. However, the amount of the adhering rust is slightly smaller than that on #G (degree of coloration is slightly lower than that of #G).

The method of removing rust and the method of evaluating characteristics are the same as in Experiment 2.

Results of the experiment: shown in Table 3.

TABLE 3

| | Formulation No. | | | | | | | | | | |
|---|---|---|---|---|---|---|---|---|---|---|---|
| | Ex. 11 | | | | | Com. Ex. 9 | | | | | Control |
| Active ingredient % in | EDTA.4Na: 14.1% | | | | | hydrosulfite: 14.5% | | | | | RO water |
| compounded solution | NaOH: 4.1% | | | | | sodium citrate: 14.5% | | | | | |
| | thiourea dioxide: 10.0% | | | | | (RO water: 71.0%) | | | | | |
| | (RO water: 71.8%) | | | | | | | | | | |
| Storage time after preparation of compounded | 0 | 2 | 6.5 | 24 | 48 | 0 | 2 | 6.5 | 24 | 48 | |
| solution(hr × 25° C.) | | | | | | | | | | | |

| | | | |
|---|---|---|---|
| Evaluation | Treatment solution | treatment time | Evaluation results of characteristics |

| of the | aqueous 25-fold dilution | active ingredient % | 1.12% | | | | | 0 |
|---|---|---|---|---|---|---|---|---|
| degree of | | 30 minutes | 3.3 | 3.3 | 2.9 | 2.2 | 2.0 | 2.0 |
| rust | | 60 minutes | 4.8 | 4.8 | 4.6 | 2.4 | 2.1 | 2.0 |
| removal | | 90 minutes | 5.0 | 5.0 | 4.8 | 3.1 | 2.2 | 2.0 |

| | | | | |
|---|---|---|---|---|
| aqueous 50-fold dilution | active ingredient % | 0.564% | 0.56% | 0 |

| | | | | | | | | | | | |
|---|---|---|---|---|---|---|---|---|---|---|---|
| 30 minutes | 4.0 | 4.0 | 4.0 | 4.0 | 3.5 | 3.0 | 2.9 | 2.3 | 2.0 | 2.0 | 2.0 |
| 60 minutes | 5.0 | 5.0 | 5.0 | 5.0 | 5.0 | 4.5 | 4.4 | 2.8 | 2.1 | 2.0 | 2.0 |
| 90 minutes | 5.0 | 5.0 | 5.0 | 5.0 | 5.0 | 5.0 | 4.9 | 3.3 | 2.2 | 2.0 | 2.0 |

| | | | |
|---|---|---|---|
| aqueous 100-fold dilution | active ingredient % | 0.282% | 0 |

| | | | | | | |
|---|---|---|---|---|---|---|
| 30 minutes | 3.6 | 3.6 | 3.6 | 3.6 | 3.0 | 2.0 |
| 60 minutes | 5.0 | 5.0 | 5.0 | 5.0 | 4.8 | 2.0 |
| 90 minutes | 5.0 | 5.0 | 5.0 | 5.0 | 5.0 | 2.0 |

<Point of the results> The treatment solutions in the Examples made use of hydrosulfite. As compared with the composition in Comparative Example 9, the compositions in the Examples showed the following excellent characteristics:

\mathring{1} The treatment solution (stock solution) is excellent in the stability of the effect with time.

\mathring{2} The treatment solution though containing the active ingredients in lower concentrations take effect instantly for the treatment time, and shows the effect at high level.

### Example 12

### Experiment 4: Measurement of Oxidation-Reduction Potential (ORP) of the Treatment Solution

### 1) Experimental Conditions

Preparation of the treatment solution: The formulation in each of Example 11 and Comparative Example 9 was used as the stock solution, and by RO water, the stock solution in Example 11 was diluted 50-, 100- and 200-fold respectively, and the stock solution in Comparative Example 5 was diluted 25-, 50- and 100-fold respectively, and the resulting treatment solutions were left in an atmosphere at 25° C. during which ORP change was measured.

2) Measurement method: Using an ORP meter with Ag/AgCl potential as the standard, the treatment solution at a temperature of 25° C. was measured.

3) Results of the experiment: shown in table 4.

TABLE 4

| | | Elapsed time after | | |
|---|---|---|---|---|
| | | dilution (25° C. × hr) | | |
| Degree of dilution of | | ORP(mv) | | |
| the measurement solution with water | | 0 hr | 1.5 hr | 3 hr |
| Formulated solution in Ex. 11 | 50 | −757 | −753 | −730 |
| | 100 | −728 | −727 | −703 |
| | 200 | −685 | −670 | −663 |
| Formulated solution in Com. Ex. 9 | 25 | −619 | −601 | −573 |
| | 50 | −607 | −591 | −563 |
| | 100 | −580 | −520 | −444 |
| RO water | | +73 | +85 | +105 |

<Point of the results> The treatment solution in this example showed ORP which was negatively larger than in the comparative example, and indicated less change in ORP with time. That is, it can be said that the treatment solution in this example exhibits a durable and strong reducing force.

### Examples 13 to 15

### Experiment 5: Evaluation of Characteristics of the Powder Composition

### 1) Experimental Conditions

### \mathring{1} Starting Materials Used

Reducing agent: the same thiourea dioxide as in Experiment 1.

Basic compound: sodium carbonate (powder)

Metal chelating agent: EDTA·4Na.4H₂O (powder), i.e. CHELEST 400 manufactured by Chelest Co.

sodium tripolyphosphate (anhydrous powder also acting as a basic compound)

### \mathring{2} Preparation of the Treatment Solution

The starting materials used were dissolved in RO water in combinations and amounts shown in Table 5, to give 1% compositions for rust removal. The resulting compositions for rust removal were subjected to the following evaluation of characteristics such as rust-removing effect etc.

### \mathring{3} Evaluation of the Rust-Removing Effect

Material to be treated: An external-pressure-type hollow fiber ultrafiltration (UF) membrane made of polyether sulfone in a module was rusted by using it in a water treatment unit for about 1 year, then the hollow fibers were recovered by dismantling the module and cut into fibers of 10 cm in length, and 10 cut fibers were arranged on a flat surface and fixed at one end to prepare a test specimen. The outward appearance of the hollow fibers had a yellowish brown adhering material, and it was confirmed in separate analysis that the adhering material contains iron rust and protein.

Method of rust removal, method of evaluating characteristics: conducted in accordance with the method in Experiment 1.

Results of the experiment: shown in Table 5.

TABLE 5

| | | | Formulation No. | | | |
|---|---|---|---|---|---|---|
| | | | | | | Control |
| Items for | | | | | | RO |
| evaluation of characteristics | | | Ex. 13 | Ex. 14 | Ex. 15 | water |
| Composition | Powdery mixture | EDTA.4Na.4H2O | | 16.7 | 66.7 | |
| | (compounding ratio in | sodium tripolyphosphate | 33.4 | 33.3 | | |
| | apparent weight g) | sodium carbonate | 33.3 | 16.7 | | |
| | | thiourea dioxide | 33.3 | 33.3 | 33.3 | |
| | | total | 100 | 100 | 100 | |
| | | solidification of the | ◯ | Δ | X | |
| | | compounded powder with time* | | | | |
| Preparation of the treatment | | | 1% aqueous solution | | | RO |
| solution | | | in RO water | | | water |
| Evaluation of | treatment solution pH | just after preparation | 9.70 | 9.00 | 8.79 | 6.10 |
| characteristics | | 3 hours after preparation | 9.50 | 8.50 | 8.09 | 6.12 |
| | degree of rust removal | 40 minutes | 2.5 | 3.0 | 3.5 | 1.0 |
| | (rusted hollow fiber | 90 minutes | 3.8 | 4.5 | 4.9 | 1.0 |
| | UF membrane) | 180 minutes | 4.5 | 5.0 | 5.0 | 1.0 |

Note)
*The compounded powder was placed in an open container and stored in a 60 to 80% RH atmosphere for 3 days, and evaluated for the solidification (or fluidity) of the powder.
Evaluation criteria: The degree of solidification is decreased in the order of X < Δ < ◯.

<Point of the results> According to this experiment, the powdery compounded products meeting the requirements of the present invention were prepared to form aqueous solutions, and the following results were obtained: The aqueous solutions can be used in a system for rust removal, and the treatment solutions of the present invention demonstrate a sufficient effect on treatment for removing rust from a rusted filtration membrane.

The advantageous effects achieved by the method of removing rust according to the present invention can be summarized as follows:

\mathring{1} Treatment for rust removal can be carried out at ordinary temperatures to exhibit an quick effect.

\mathring{2} An excellent rust-removing effect can be brought about even by the treatment solution at very low concentration.

\mathring{3} The treatment solution can also be prepared at high concentration, and the high conc. treatment solution is excellent in the stability of effect with time.

\mathring{4} There is less generation of an offensive smell from the treatment solution.

\mathring{5} The treatment solution just after preparation shows alkalinity in the range of pH 8 to 11, but the pH is decreased gradually to 7 to 9 in several hours, and thus the treatment solution will not facilitate corrosion of metallic materials or deterioration in cement materials.

Practical aspects of these characteristics are as follows:

The feature of \mathring{1} is related to many advantages in practical use; that is, the rust-removing treatment can be completed for a short time, troublesome treatment for increasing the temperature of the treatment solution is not necessary, and the deterioration in physical properties of the treated material, caused by an increase in temperature, can be reduced.

Further, the features of \mathring{2} and \mathring{3} are related to an advantage that a system in which a small amount of high conc. treatment solution is first prepared, and then a final treatment solution is successively obtained in a large amount in a treatment field by diluting the conc. solution at high degree with water, and a space for storing the treatment solution can thus be reduced.

Further, all items enumerated as advantages contribute finally to a reduction in the cost of rust-removing treatment. That is, it can be said that the method of the present invention is a valuable technique of highly practical usability.

What is claimed is:

1. A composition for rust removal which is a water soluble composition comprising a basic compound, a water-soluble metal chelating agent and thiourea dioxide, said composition showing an alkalinity upon dissolution in an aqueous medium.

2. A composition according to claim 1, in which the basic compound is selected from a caustic alkali and a water soluble salt of a weak acid with caustic alkali.

3. A composition according to claim 1, in which the water-soluble metal chelating agent is an aminocarboxylic acid-based compound.

4. A composition according to claim 1 which shows a pH of 8 or more in an aqueous solution when it is just prepared by dissolving the composition in an aqueous medium a solution of the composition for rust removal dissolved in an aqueous medium has a pH of 8 or more just after preparation.

5. A composition according to claim 1, in which when it is dissolved in an aqueous medium, the resulting solution contains 0.001 to 30 wt % of the basic compound selected from a caustic alkali and a water soluble salt of weak acids with caustic alkalis, 0.01 to 30 wt % of the water-soluble metal chelating agent of an aminocarboxylic acid-based compound and 0.01 to 30 wt % thiourea dioxide and shows a pH of 8 or more just after dissolution.

6. A composition according to claim 1, in which two components of the basic compound and the water-soluble metal chelating agent was dissolved in an aqueous medium to yield two components solution, followed by dissolving thiourea dioxide in its solution just prior to use as rust removal was dissolved.

7. A method of removing rust comprising the step of bringing an alkaline solution of a composition for rust removal as claimed in any one of claims 1 to 6, in an aqueous medium into contact for a predetermined time with a rusted surface of a material to be treated.

8. A method according to claim 7, in which the material to be treated is a dialyzer, and the composition for rust removal contains 0.05 to 2 wt % in an solution.
